(19) United States
(12) Patent Application Publication
(10) Pub. No.: US 2025/0128882 A1
(43) Pub. Date: Apr. 24, 2025

(54) METHOD FOR GOODS SORTING, SERVER, SYSTEM FOR GOODS SORTING, AND STORAGE MEDIUM

(71) Applicant: HAI ROBOTICS CO., LTD., Shenzhen (CN)

(72) Inventors: Han LIN, Shenzhen (CN); Xiao FENG, Shenzhen (CN)

(73) Assignee: HAI ROBOTICS CO., LTD., Shenzhen (CN)

(21) Appl. No.: 19/006,073

(22) Filed: Dec. 30, 2024

Related U.S. Application Data
(63) Continuation-in-part of application No. PCT/CN2023/112571, filed on Aug. 11, 2023.

(30) Foreign Application Priority Data
Aug. 17, 2022 (CN) 202210988229.5

(51) Int. Cl. B65G 1/137; G06Q 10/08

(52) U.S. Cl. CPC B65G 1/1371; G06Q 10/08

(57) ABSTRACT

This application provides a method and an apparatus goods sorting, a server, a system for goods sorting, and a storage medium. A method for goods picking provided in this application includes: determining at least one source container location and a target container location according to target item information included in order information; generating a source container delivery instruction according to the at least one source container location, generating a target container delivery instruction according to the source container delivery instruction and the target container location, sending the source container delivery instruction to cause a source delivery assembly to deliver the at least one source container to a preset pickup location, and sending the target container delivery instruction to cause a target delivery assembly to deliver a target container to a preset placement location; and generating a sorting instruction according to the source container delivery instruction to cause a sorting apparatus to pick a target item from the source container located in the preset pickup location and place the target item in the target container located in the preset placement location.

### CROSS-REFERENCES

This application is a continuation-in-part application of International Patent Application No. PCT/CN2023/112571 filed on Aug. 11, 2023, which claims priority to Chinese Patent Application No. 202210988229.5, filed on Aug. 17, 2022, the disclosures of which are incorporated herein by reference in their entireties.

### TECHNICAL FIELD

This application relates to the field of smart warehousing technologies, and in particular, to a method and an apparatus for goods sorting, a server, a system for goods sorting, and a storage medium.

### BACKGROUND OF THE INVENTION

When receiving an outbound order, a warehousing system processes the order and then identifies information about to-be-packed goods. A warehousing robot transfers a rack in which a plurality of to-be-picked containers are located in containing the to-be-packed goods. A handling robot sequentially handles the to-be-picked containers to a conveying belt. The conveying belt sequentially conveys all the to-be-picked containers to a sorting workstation. In this way, a sorting person can sequentially pick the to-be-packed goods from the to-be-picked containers according to the information about the to-be-packed goods prompted by the sorting workstation, and place the to-be-packed goods in packing containers, to complete sorting and packing of the goods.

However, when the quantity of to-be-picked containers is large, because operation efficiency of human sorting is lower than transfer efficiency of the conveying belt transferring the to-be-picked containers, a mismatch between the human and machine operations easily occurs. This causes an accumulation of to-be-picked containers on the conveying belt, affecting efficiency of goods sorting.

### SUMMARY OF THE INVENTION

This application provides a method and an apparatus for goods sorting, a server, a system for goods sorting, and a storage medium, achieving automated picking of items and improving outbound efficiency of goods.

According to a first aspect, this application provides a method for goods sorting, where the method includes:
parsing received order information to obtain target item information, and determining at least one source container location and a target container location according to the target item information;
generating a source container delivery instruction according to the at least one source container location, and generating a target container delivery instruction according to the source container delivery instruction and the target container location;
sending the source container delivery instruction of the at least one source container to cause a source delivery assembly to deliver the at least one source container to a preset pickup location, and sending the target container delivery instruction to cause a target delivery assembly to deliver a target container to a preset placement location; and
generating a sorting instruction corresponding to each source container according to the source container delivery instruction of the at least one source container, and sending the sorting instruction to cause a sorting apparatus to pick a target item from the source container located in the preset pickup location and place the target item in the target container located in the preset placement location.

In some possible embodiments, the determining at least one source container location and a target container location according to the target item information includes:
obtaining all target item identifiers included in the target item information;
determining the source container location corresponding to each of the target item identifiers, the source container location including a source rack storage location where the source container is located and a storage location of the source container on a source rack; and

determining the target container location according to a preset distribution rule, the target container location including a target rack storage location where the target container is located and a storage location of the target container on a target rack.

In some possible embodiments, the generating a source container delivery instruction according to the at least one source container location includes:
determining a source rack arrangement order and a source container arrangement order according to the at least one source container location;
determining, from the source delivery assembly, a source warehousing robot corresponding to each source rack, and determining a source transfer instruction corresponding to each source rack according to each source rack location and the source rack arrangement order, the source transfer instruction including a source transfer path of the source rack;
determining, from the source delivery assembly, a source handling robot corresponding to each source container, and determining a source handling instruction corresponding to the source container according to the storage location of each source container on the source rack, the source handling instruction including a source handling path of the source container;
generating a source conveying instruction according to the source container arrangement order, the source conveying instruction including conveying times, conveying speeds, and waiting duration of the at least one source container; and
determining the source transfer instruction corresponding to each source rack, the source handling instruction corresponding to each source container, and the source conveying instruction as the source container delivery instruction.

In some possible embodiments, the generating a target container delivery instruction according to the source container delivery instruction and the target container location includes:
determining, from the target delivery assembly, a target warehousing robot corresponding to the source rack, and determining a target transfer instruction according to the target container location, the target transfer instruction including a target transfer path for transferring the target rack;
determining, from the target delivery assembly, a target handling robot corresponding to the source container and determining a target handling instruction according to the storage location of the target container on the target rack, the target handling instruction including a target handling path for handling the target container;
generating a target conveying instruction according to a source conveying instruction included in the source container delivery instruction, the target conveying instruction including a conveying time, a conveying speed, and a waiting duration for conveying the target container; and
determining the target transfer instruction, the target handling instruction, and the target conveying instruction as the target container delivery instruction.

In some possible embodiments, the source delivery assembly includes a source conveying apparatus, and the sending the source container delivery instruction of the at least one source container to cause a source delivery assembly to deliver the at least one source container to a preset pickup location includes:
sending the source transfer instruction corresponding to each source rack to the source warehousing robot corresponding to each source rack to cause the source warehousing robot to transfer the source rack to a preset placement stop point according to the source transfer path included in the source transfer instruction;
separately sending the source handling instruction corresponding to each source container to the source handling robot corresponding to each source container to cause each source handling robot to handle the corresponding source container to a placement entrance location of the source conveying apparatus according to the source handling path included in the received source handling instruction; and
sending the source conveying instruction corresponding to the at least one source container to the source conveying apparatus to cause the source conveying apparatus to sequentially convey each source container to the preset pickup location according to the conveying times, the conveying speeds, and the waiting duration included in the source conveying instruction corresponding to the at least one source container.

In some possible embodiments, the target delivery assembly includes a target conveying apparatus, and the sending the target container delivery instruction to cause a target delivery assembly to deliver a target container to a preset placement location includes:
sending the target transfer instruction corresponding to the target rack to the target warehousing robot to cause the target warehousing robot to transfer the target rack to a preset pickup stop point according to the target transfer path included in the target transfer instruction;
sending the target handling instruction to the target handling robot to cause the target handling robot to handle the target container to a placement entrance location of the target conveying apparatus according to the target handling path included in the target handling instruction; and
sending the target conveying instruction to the target conveying apparatus to cause the target conveying apparatus to convey the target container to the preset placement location according to the conveying time, the conveying speed, and the waiting duration for the target container included in the target conveying instruction.

In some possible embodiments, the generating a sorting instruction corresponding to each source container according to the source container delivery instruction of the at least one source container includes:
determining a pickup moment of a sorting operation corresponding to the at least one source container according to the conveying times, the conveying speeds, and the waiting duration of the at least one source container included in the source container delivery instruction; and
generating the sorting instruction for each source container according to the quantity of sorting operations and the pickup moment of the sorting operation corresponding to each source container.

In some possible embodiments, the sending the sorting instruction to cause a sorting apparatus to pick a target item from the source container located in the preset pickup location and place the target item in the target container located in the preset placement location includes:
sending the sorting instruction to the sorting robot to cause the sorting robot to pick the target item from the source container located in the preset pickup location according to the pickup moment of the sorting operation included in each sorting instruction and a pickup operation program, place the target item in the target container located in the preset placement location according to a placement operation program, and repeatedly perform pickup operations and placement operations according to the quantity of operations included in the sorting instruction.

In some possible embodiments, the sorting apparatus is a sorting robot, and before the sending the sorting instruction, the method further includes:
determining a pickup operation parameter according to the preset pickup location, and determining a placement operation parameter according to the preset placement location; and
sending the pickup operation parameter and the placement operation parameter to the sorting robot to cause the sorting robot to set a pickup operation program according to the pickup operation parameter and set a placement operation program according to the placement operation parameter.

In some possible embodiments, after the sending the sorting instruction, the method further includes:
determining a source transfer-back instruction corresponding to each source rack and a source handling-back instruction corresponding to each source container according to the source transfer instructions and the source handling instructions that are included in the source container delivery instruction of the at least one source container;
separately sending each source handling-back instruction to the source handling robot corresponding to each source container to cause each source handling robot to handle the corresponding source container back to the corresponding source rack according to the received source handling-back instruction; and
separately sending each source transfer-back instruction to the source warehousing robot corresponding to each source rack to cause each source warehousing robot to transfer the corresponding source rack back to the storage location of the corresponding source rack according to the received source transfer-back instruction.

In some possible embodiments, after the sending the sorting instruction, the method further includes:
determining a target transfer-back instruction corresponding to the target rack and a target handling-back instruction corresponding to the target container according to a target transfer instruction and a target handling instruction corresponding to the target container that are included in the target container delivery instruction;
sending the target handling-back instruction to the target handling robot corresponding to the target container to cause the target handling robot to handle the target container back to the target rack according to the received target handling-back instruction; and

sending the target transfer-back instruction to the target warehousing robot to cause the target warehousing robot to transfer the target rack back to a storage location of the target rack according to the received target transfer-back instruction.

In some possible embodiments, after the generating a sorting instruction corresponding to each source container according to the source container delivery instruction of the at least one source container, the method further includes:
determining a verification time node for each source container according to the quantity of sorting operations and the pickup moment of the sorting operation included in the sorting instruction of each source container;
generating an image acquisition instruction according to the verification time node, and sending the image acquisition instruction to an image acquisition apparatus to cause the image acquisition apparatus to capture a to-be-verified image of the target container located in the preset placement location; and
receiving the to-be-verified image sent by the image acquisition apparatus, determining the quantity of to-be-verified items included in the to-be-verified image according to a preset image processing model, and if the quantity of to-be-verified items is not equal to the quantity of sorting operations, generating prompt information and sending the prompt information to a management terminal to prompt that goods sorting fails.

According to a second aspect, this application further provides an apparatus for goods sorting, including:
a determining module, configured to parse received order information to obtain target item information, and determine at least one source container location and a target container location according to the target item information;
a generation module, configured to generate a source container delivery instruction according to the at least one source container locations, and generating a target container delivery instruction according to the source container delivery instruction and the target container location;
a sending module, configured to send the source container delivery instruction of the at least one source container to cause a source delivery assembly to deliver the at least one source container to a preset pickup location, and sending the target container delivery instruction to cause a target delivery assembly to deliver a target container to a preset placement location; and
a sorting module, configured to generate a sorting instruction corresponding to each source container according to the source container delivery instruction of the at least one source container, and sending the sorting instruction to cause a sorting apparatus to pick a target item from the source container located in the preset pickup location and place the target item in the target container located in the preset placement location.

According to a third aspect, this application further provides a server, including:
a processor; and
a memory, configured to store executable instructions of the processor, where

the processor is configured to perform any method for goods sorting according to the first aspect by executing the executable instructions.

According to a fourth aspect, this application further provides a system for goods sorting, including: the server according to any item of the third aspect, a source delivery assembly, a target delivery assembly, a sorting apparatus, a rack, and a picking workstation, where
the rack includes a source rack and a target rack, where the source rack is configured to store a source container, and the target rack is configured to store a target container;
the source delivery assembly is configured to deliver the at least one source container to a preset pickup location of the picking workstation in response to a source container delivery instruction;
the target delivery assembly is configured to deliver the target container to a preset placement location of the picking workstation in response to a target container delivery instruction;
the sorting apparatus is configured to pick a target item from the source container located in the preset pickup location and place the target item in the target container located in the preset placement location in response to a sorting instruction; and
the server is configured to executable instructions to perform any method for goods sorting according to the first aspect.

According to a fifth aspect, an embodiment of this application further provides a computer-readable storage medium, storing a computer-executable instruction, where when a processor executes the computer-executable instruction, any method for goods sorting according to the first aspect is implemented.

According to a sixth aspect, an embodiment of this application further provides a computer program product, including a computer-executable instruction, where when a processor executes the computer-executable instruction, any method for goods sorting according to the first aspect is implemented.

This application provides a method and an apparatus for goods sorting, a server, a system for goods sorting, and a storage medium. A source container containing a target item is delivered to a preset pickup location, and a target container for placing the target item is delivered to a preset placement location. In addition, a sorting apparatus is controlled to pick the target item from the source container located in the preset pickup location and place the target item in the target container located in the preset placement location. This can achieve automated picking of items, thereby improving sorting efficiency of the items and outbound efficiency of goods.

### BRIEF DESCRIPTION OF DRAWINGS

To describe the technical solutions of the embodiments of this application more clearly, the following briefly introduces the accompanying drawings required for describing the embodiments. Apparently, the accompanying drawings in the following description show only some embodiments of this application. A person of ordinary skill in the art may still derive other drawings from these accompanying drawings without creative efforts.

FIG. 1 is a schematic structural diagram of a system for goods sorting according to a first embodiment of this application.

FIG. 2 is a schematic structural diagram of a picking workstation according to a second embodiment of this application.

FIG. 3 is a schematic flowchart of a method for goods sorting according to a third embodiment of this application.

FIG. 4 is a schematic flowchart of a method for goods sorting according to a fourth embodiment of this application.

FIG. 5 is a schematic flowchart of a method for goods sorting according to a fifth embodiment of this application.

FIG. 6 is a schematic flowchart of a method for goods sorting according to a sixth embodiment of this application.

FIG. 7 is a schematic structural diagram of an apparatus for goods sorting according to a seventh embodiment of this application.

FIG. 8 is a schematic structural diagram of a server according to an eighth embodiment of this application.

### DETAILED DESCRIPTION

In order to make the objectives, technical solutions and advantages of the embodiments of this application clearer, the following clearly and completely describes the technical solutions in the embodiments of this application with reference to the accompanying drawings in the embodiments of this application. Apparently, the described embodiments are some rather than all of the embodiments of this application. All other embodiments obtained by a person of ordinary skill in the art based on the embodiments of this application without creative efforts fall within the protection scope of this application.

The terms such as “first”, “second”, “third”, and “fourth” etc. (if any) in the specification and claims of this application and in the accompanying drawings are used for distinguishing between similar objects and not necessarily used for describing any specific order or sequence. It is to be understood that such used data is interchangeable where appropriate so that the embodiments of this application described here can be implemented in an order other than those illustrated or described here. Moreover, the terms “include”, “contain” and any other variants mean to cover the non-exclusive inclusion, for example, a process, method, system, product, or device that includes a list of steps or units is not necessarily limited to those expressly listed steps or units, but may include other steps or units not expressly listed or inherent to such a process, method, system, product, or device.

With the rise and increasing development of e-commerce and online shopping, there is a huge development opportunity for the intelligence of warehousing and logistics of goods. In a logistics process of goods, when receiving an outbound order, a warehousing system processes the order and then identifies information about to-be-packed goods. A warehousing robot transfers a rack in which a plurality of to-be-picked containers are located in containing the to-be-packed goods. A handling robot sequentially handles the to-be-picked containers to a conveying belt. The conveying belt sequentially conveys all the to-be-picked containers to a sorting workstation. In this way, a sorting person can sequentially pick the to-be-packed goods from the to-be-picked containers according to the information about the to-be-packed goods prompted by the sorting workstation, and place the to-be-packed goods in packing containers, to complete sorting and packing of the goods. However, when the quantity of to-be-picked containers is large, because operation efficiency of human sorting is lower than transfer efficiency of the conveying belt transferring the to-be-picked containers, a mismatch between the human and machine operations easily occurs. This causes an accumulation of to-be-picked containers on the conveying belt, affecting efficiency of goods sorting.

In view of the foregoing technical problems, according to a method for goods sorting provided in this application, sorting efficiency of goods is improved by implementing an automated sorting process of goods.

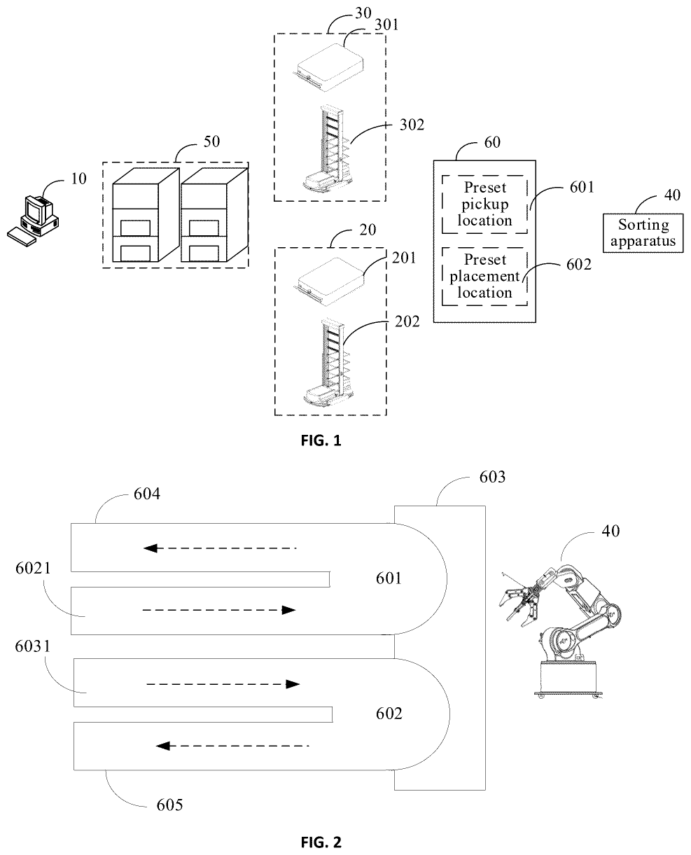

FIG. 1 is a schematic structural diagram of a system for goods sorting according to a first embodiment of this application. As shown in FIG. 1, the system for goods sorting includes a server 10, a source delivery assembly 20, a target delivery assembly 30, a sorting apparatus 40, a rack 50, and a picking workstation 60. For example, the server 10 establishes a communication connection to each of the source delivery assembly 20, the target delivery assembly 30, and the sorting apparatus 40. The source delivery assembly 20 receives an instruction delivered by the server 10, to deliver a source container to a preset pickup location. The target delivery assembly 30 may receive an instruction delivered by the server 10, to deliver a target container to a preset placement location. The sorting apparatus 40 may also receive an instruction delivered by the server 10, to pick a target item from the source container at the preset pickup location 601 of the picking workstation 60 and place the target item into the target container at the preset placement location 602, to complete the item picking process.

It should be noted that, in this embodiment, the server may be in communication connection with a plurality of source delivery assemblies 20 and a plurality of target delivery assemblies 30, generate corresponding container delivery instructions according to locations and delivery paths of the plurality of source delivery assemblies 20 and the plurality of target delivery assemblies 30 at the same time, and send the delivery instructions to each corresponding source delivery assembly 20 and each corresponding target delivery assembly 30.

For example, each source delivery assembly 20 includes a source warehousing robot 201 and a source handling robot 202. Each target delivery assembly 30 includes a target warehousing robot 301 and a target handling robot 302.

For example, as shown in FIG. 2, the picking workstation 60 includes a picking workbench 603, a source conveying belt 604, and a target conveying belt 605. A preset placement location 602 and a preset pickup location 601 are set in the picking workbench. The source conveying belt conveys a container at a source conveying belt entrance 6021 to the preset pickup location 601. The target conveying belt conveys a container at a target conveying belt entrance 6031 to the preset placement location 602.

For example, as shown in FIG. 2, the sorting apparatus 40 is mounted on the picking workbench 601. Specifically, the sorting apparatus 40 is a robotic arm, configured to perform an automated sorting operation.

It should be noted that, the source conveying belt and the target conveying belt are arranged in a mirror image and have the same transmission speed. After the source conveying belt conveys the source container to the preset pickup location and the target conveying belt conveys the target container at the target conveying belt entrance to the preset placement location, and after item picking is completed, the source conveying belt conveys the source container from the preset pickup location to the source conveying belt exit, and the target conveying belt conveys the target container from the preset placement location to the target conveying belt exit.

As shown in FIG. 2, the picking workstation is further provided with a source rack stop point and a target rack stop point, respectively configured for placement of a plurality of source racks and a plurality of target racks.

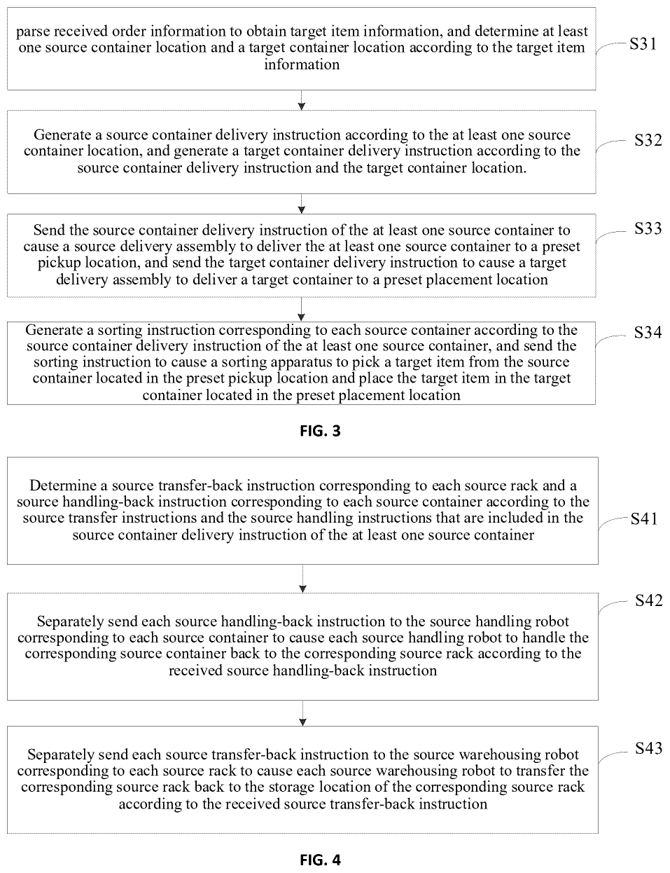

FIG. 3 is a schematic flowchart of a method for goods sorting according to a third embodiment of this application. This embodiment may be performed by the server in the embodiment shown in FIG. 1. This embodiment is not specially limited herein. As shown in FIG. 3, the method includes:

Step S31: parse received order information to obtain target item information, and determine at least one source container location and a target container location according to the target item information.

In this embodiment, after receiving order information of goods, a server in a warehousing system determines each storage information of goods in the order information according to a map relationship between goods information and the storage information which stored in the server. The storage information of goods includes a source container location in which the goods are located. Specifically, the source container location includes a source rack storage location where the source container is located and a storage location of the source container on a source rack.

Specifically, the determining at least one source container location and a target container location according to the target item information includes the following steps: obtaining all target item identifiers included in the target item information; determining the source container location corresponding to each of the target item identifiers, the source container location including a source rack storage location where the source container is located and a storage location of the source container on a source rack; and determining the target container location according to a preset distribution rule, the target container location including a target rack storage location where the target container is located and a storage location of the target container on a target rack.

Specifically, the determining the target container location according to the preset allocation rule can involve determining target containers for storing the target goods according to prestored storage specifications of empty containers and the maximum volume of a single good among all target goods included in the target good information and determining the target container location. Alternatively, it can involve determining target containers for storing the target goods according to prestored storage specifications of empty containers and the total volume of all items included in the target good information and determining the target container location. Another approach is selecting the target container from multiple empty containers pre-allocated to the picking workstation and determining the target container location, where the picking workstation is the station executing the picking operation for the target goods.

It should be noted that, the order information includes one or more target items to be outbound. Correspondingly, one or more source containers may be needed, and more source containers may be located on a plurality of different racks. In addition, the quantity of target container may be one or more. If the quantity of target items is less, one target container is enough, whereas if the quantity of target items is large, more target containers may be needed. And, the target container may store items of an order or a plurality of orders of the same user.

For example, a system for goods picking includes a plurality of picking workstations. In an outbound process of the target goods, the outbound order is bound to the correspondingly picking workstation, the target container corresponding to the outbound order and the target container location are determined according to the preset distribution rule. The target container is a container which is dedicated to storing items to be outbound.

Step S32: Generate a source container delivery instruction according to the at least one source container location, and generate a target container delivery instruction according to the source container delivery instruction and the target container location.

In this embodiment, after the at least one source container location corresponding to all outbound target items are determined, a source container delivery instruction may be generated. Specifically, the source container delivery instruction is used for triggering a process of delivering a rack of a source container to the picking workstation and delivering the source container to a preset pickup location of the picking workstation.

In this embodiment, specifically, the generating a source container delivery instruction according to the at least one source container location includes the following steps:
determining a source rack arrangement order and a source container arrangement order according to the at least one source container location; specifically, determining, from the source delivery assembly, a source warehousing robot corresponding to each source rack, and determining a source transfer instruction corresponding to each source rack according to each source rack location and the source rack arrangement order, the source transfer instruction including a source transfer path of the source rack; determining, from the source delivery assembly, a source handling robot corresponding to each source container, and determining a source handling instruction corresponding to the source container according to the storage location of each source container on the source rack, the source handling instruction including a source handling path of the source container; generating a source conveying instruction according to the source container arrangement order, the source conveying instruction including conveying times, conveying speeds, and waiting duration of the at least one source container; and determining the source transfer instruction corresponding to each source rack, the source handling instruction corresponding to each source container, and the source conveying instruction as the source container delivery instruction.

In this embodiment, a source rack stop point dedicated to docking of the source rack is set on the side of the picking workstation. After the at least one source container location is confirmed, a source rack arrangement order is determined, that is, arrangement location of the at least one source rack at the source rack stop point is determined. After the arrangement location of the at least one source rack at the source rack stop point is determined, a source transfer path of each source rack is determined according to each source rack location and the arrangement location at the source rack stop point.

In this embodiment, after the at least one target container location corresponding to all outbound target items are determined, a target container delivery instruction may be generated. Specifically, the target container delivery instruction is used for triggering a process of delivering a target rack of a target container to the picking workstation and delivering the target container to a preset placement location of the picking workstation.

Specifically, the generating a target container delivery instruction according to the source container delivery instruction and the target container location includes the following steps:

determining, from the target delivery assembly, a target warehousing robot corresponding to the source rack, and determining a target transfer instruction according to the target container location, the target transfer instruction including a target transfer path for transferring the target rack; determining, from the target delivery assembly, a target handling robot corresponding to the source container and determining a target handling instruction according to the storage location of the target container on the target rack, the target handling instruction including a target handling path for handling the target container; generating a target conveying instruction according to a source conveying instruction included in the source container delivery instruction, the target conveying instruction including a conveying time, a conveying speed, and a waiting duration for conveying the target container; and determining the target transfer instruction, the target handling instruction, and the target conveying instruction as the target container delivery instruction.

In this embodiment, a target rack stop point dedicated to docking of the target rack is set on the side of the picking workstation. After the at least one target container location is confirmed, a target rack arrangement order is determined, that is, arrangement locations of the at least one target rack at the target rack stop point is determined. After the arrangement locations of the at least one target rack at the target rack stop point is determined, a target transfer path of each target rack is determined according to each target rack location and the arrangement location at the target rack stop point.

A conveying process of the target conveying belt is subject to the conveying time, the conveying speed, and the waiting duration in the target conveying instruction. The conveying time, the conveying speed, and the waiting duration in the target conveying instruction are related to the conveying time, the conveying speed, and the waiting duration in the source conveying instruction. That is, the conveying time and the conveying speed in the target conveying instruction are determined according to a conveying time, a conveying speed, and a waiting duration included in a source conveying instruction of the at least one source container corresponding to the target container. That is, the conveying time, the conveying speed, and the waiting duration in the transfer process of the target conveying belt are determined according to the conveying time, the conveying speed, and the waiting duration of the source conveying belt, to ensure that the at least one source container corresponding to the order and the target container are simultaneously conveyed to the preset pickup location and the preset placement location of the picking workstation.

Step S33: Send the source container delivery instruction of the at least one source container to cause a source delivery assembly to deliver the at least one source container to a preset pickup location, and send the target container delivery instruction to cause a target delivery assembly to deliver a target container to a preset placement location.

Specifically, the source delivery assembly includes a source conveying apparatus, and the sending the source container delivery instruction of the at least one source container to cause a source delivery assembly to deliver the at least one source container to a preset pickup location. For example, that the source delivery assembly delivers the at least one source container to a preset pickup location includes the following steps:

First: Send the source transfer instruction corresponding to each source rack to the source warehousing robot corresponding to each source rack to cause the source warehousing robot to transfer the source rack to a preset placement stop point according to the source transfer path included in the source transfer instruction.

Second: Separately send the source handling instruction corresponding to each source container to the source handling robot corresponding to each source container to cause each source handling robot to handle the corresponding source container to a placement entrance location of the source conveying apparatus according to the source handling path included in the received source handling instruction.

Finally: Send the source conveying instruction corresponding to the at least one source container to the source conveying apparatus to cause the source conveying apparatus to sequentially convey each source container to the preset pickup location according to the conveying times, the conveying speeds, and the waiting duration included in the source conveying instruction corresponding to the at least one source container.

It should be noted that, the source transfer instruction is used for triggering a transportation process of a source rack, and the source handling instruction is used for triggering a process of handling a source container to a source conveying belt entrance. When the source container is handled to the source conveying belt entrance, the source conveying belt conveys the source container at the entrance to the preset pickup location according to the conveying times, conveying speeds, and the waiting duration in the source conveying instruction.

Specifically, the target delivery assembly includes a target conveying apparatus. The target container delivery instruction is sent to cause the target delivery assembly to deliver the target container to the preset placement location. For example, that the target delivery assembly delivers the target container to the preset placement location includes the following steps:

First: Send the target transfer instruction corresponding to the target rack to the target warehousing robot to cause the target warehousing robot to transfer the target rack to a preset pickup stop point according to the target transfer path included in the target transfer instruction.

Second: Send the target handling instruction to the target handling robot to cause the target handling robot to handle the target container to a placement entrance location of the target conveying apparatus according to the target handling path included in the target handling instruction; and

Finally: Send the target conveying instruction to the target conveying apparatus to cause the target conveying apparatus to convey the target container to the preset placement location according to the conveying time, the conveying speed, and the waiting duration for the target container included in the target conveying instruction.

It should be noted that, the target transfer instruction is used for triggering a transportation process of a target rack, and the target handling instruction is used for triggering a process of handling a target container to a target conveying belt entrance. When the target container is handled to the target conveying belt entrance, the target conveying belt conveys the target container at the entrance to the preset placement location according to the conveying times, conveying speeds, and the waiting duration in the target conveying instruction.

For example, the source handling robot and the target handling robot are robots that handle containers, and each specifically include a robot body, a base, a handling apparatus, an adjustment component, and a plurality of slots provided on the robot body. The adjustment component is configured to drive the handling apparatus to move up and down, to cause the handling apparatus to be aligned with any slot on the robot body or a storage location of any container on the rack. The handling apparatus can rotate with a vertical direction as an axis to adjust an orientation, so as to be aligned with the slot or the storage location on the rack.

It should be noted that, in this embodiment, the source warehousing robot and the target warehousing robot are each an automated guided vehicle (AGV), configured to transfer a rack in a goods sorting system. The source warehousing robot transfers, according to the source transfer path, the source rack to the arrangement location corresponding to the source rack stop point. The target warehousing robot delivers, according to the target transfer path, the target rack to the arrangement location corresponding to the target rack stop point.

Step S34: Generate a sorting instruction corresponding to each source container according to the source container delivery instruction of the at least one source container, and send the sorting instruction to cause a sorting apparatus to pick a target item from the source container located in the preset pickup location and place the target item in the target container located in the preset placement location.

For example, the sorting apparatus is a robotic arm fixedly mounted on the picking workstation, and is configured to perform a process of picking a target item from the source container at the preset pickup location of the picking workstation, and placing the target item into the target container at the preset placement location, to complete automatic picking of items.

Specifically, the generating a sorting instruction corresponding to each source container according to the source container delivery instruction of the at least one source container includes the following steps:

determining a pickup moment of a sorting operation corresponding to the at least one source container according to the conveying times, the conveying speeds, and the waiting duration of the at least one source container included in the source container delivery instruction; and generating the sorting instruction for each source container according to the quantity of sorting operations and the pickup moment of the sorting operation corresponding to each source container.

It should be noted that, a time for delivering the at least one source container to the preset pickup location coincides with a time for delivering the target container to the preset placement location. After the at least one source container is delivered to the preset pickup location, a waiting duration at the preset pickup location is set for the source container. Determine the waiting duration at the preset pickup location according to the sorting rate and the quantity of target items to be picked from the source container. The waiting duration at the preset placement location is set for the target container according to the waiting duration of the source container at the preset pickup location. In this way, the sorting robot can pick, within the waiting duration, the target item according to the pickup moment set by the sorting operation, and place the target item in the target container. The sorting rate is the quantity of goods picks performed by the sorting robot within one minute.

In conclusion, according to the method for goods sorting provided in this embodiment of the present disclosure, the source container containing the target item is delivered to the preset pickup location, and the target container for placing the target item is delivered to the preset placement location. This triggers the automated picking process of the sorting apparatus, thereby improving sorting efficiency of items and outbound efficiency of goods.

In a possible implementation, the sorting apparatus is a sorting robot. For example, before the sending the sorting instruction in step S34 of the embodiment of FIG. 3, the method for goods sorting provided in the embodiments of the present disclosure may further include the following steps:

determining a pickup operation parameter according to the preset pickup location, and determining a placement operation parameter according to the preset placement location; and sending the pickup operation parameter and the placement operation parameter to the sorting robot to cause the sorting robot to set a pickup operation program according to the pickup operation parameter and set a placement operation program according to the placement operation parameter.

For example, the sorting robot is a robotic arm. Before the robotic arm is controlled to perform an automated picking task, operation parameters of the robotic arm need to be set. Specifically, the operation parameters include the picking operation parameters and the placement operation parameter. The picking operation parameters are used for indicating such as a pickup location, a pickup height, a grasping force of the robotic arm. The placement operation parameters are used for indicating such as a placement location, and a placement height of the robotic arm.

In this embodiment, a pickup operation parameter is determined according to the preset pickup location, and a placement operation parameter is determined according to the preset placement location. In this way, the robotic arm can perform the automated picking task according to the pickup operation parameter and the placement operation parameter. Specifically, the sorting instruction is sent to the sorting robot to cause the sorting robot to pick up the target item from the source container located in the preset pickup location according to the pickup moment of the sorting operation included in the sorting instruction and the pickup operation program, place the target item in the target container located in the preset placement location according to the placement operation program, and repeatedly perform pickup and placement operations according to the quantity of operations included in the sorting instruction.

In conclusion, the automated picking operation is achieved by setting the pickup operation parameters and the placement operation parameter of the robotic arm, and improving the accuracy of item sorting operations.

FIG. 4 is a schematic flowchart of a method for goods sorting according to a fourth embodiment of this application. As shown in FIG. 4, after the sending the sorting instruction in S34 in the embodiment of FIG. 3, this embodiment provides a process of depositing the container back to the warehouse after goods are sorted. The process specifically includes the following steps:

Step S41: Determine a source transfer-back instruction corresponding to each source rack and a source handling-back instruction corresponding to each source container according to the source transfer instructions and the source handling instructions that are included in the source container delivery instruction of the at least one source container.

Step S42: Separately send each source handling-back instruction to the source handling robot corresponding to each source container to cause each source handling robot to handle the corresponding source container back to the corresponding source rack according to the received source handling-back instruction; and.

Step S43: Separately send each source transfer-back instruction to the source warehousing robot corresponding to each source rack to cause each source warehousing robot to transfer the corresponding source rack back to the storage location of the corresponding source rack according to the received source transfer-back instruction.

In this embodiment, the process of delivering the source containers back to the warehouse is similar to the outbound process of the source containers described in the embodiment of FIG. 3. That is, the source containers are first delivered back to the source racks, and then the source racks are transported back to the warehouse. Details of specific steps are not described again.

In conclusion, after the automated picking task is completed, the source containers are transferred back to the source racks, and the source racks are delivered back to the warehouse. This prevents the source containers from being accumulated on the source conveying belt and affecting subsequent picking operations, and prevents an excessively large quantity of source racks from being located at the source rack stop point and causing congestion and affecting the picking efficiency.

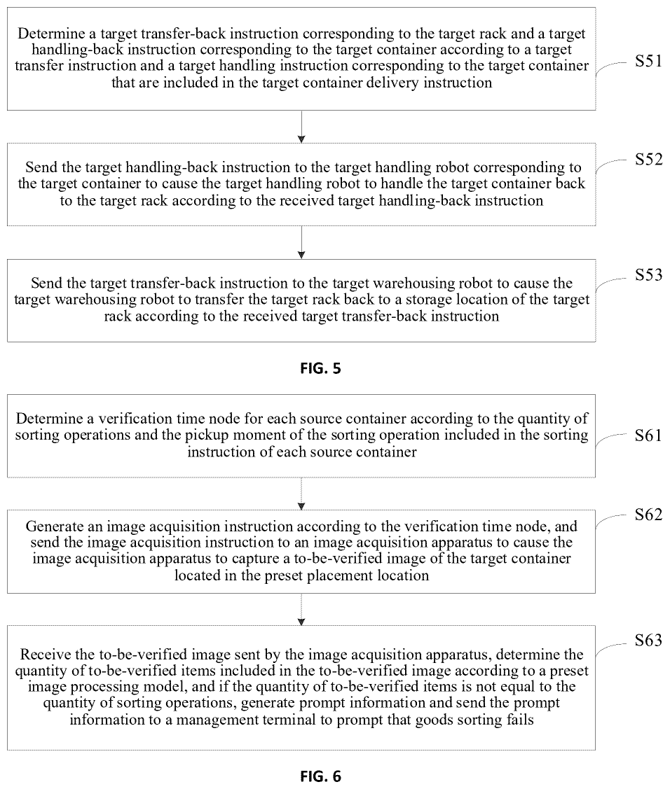

FIG. 5 is a schematic flowchart of a method for goods sorting according to a fifth embodiment of this application. As shown in FIG. 5, after the sending the sorting instruction in S34 in the embodiment of FIG. 3, this embodiment provides an implementation process of depositing the target container into the warehouse after goods are sortied. The process specifically includes the following steps:

Step S51: Determine a target transfer-back instruction corresponding to the target rack and a target handling-back instruction corresponding to the target container according to a target transfer instruction and a target handling instruction corresponding to the target container that are included in the target container delivery instruction.

Step S52: Send the target handling-back instruction to the target handling robot corresponding to the target container to cause the target handling robot to handle the target container back to the target rack according to the received target handling-back instruction; and

Step S53: Send the target transfer-back instruction to the target warehousing robot to cause the target warehousing robot to transfer the target rack back to a storage location of the target rack according to the received target transfer-back instruction.

In this embodiment, the process of delivering the target container back to the warehouse is similar to the outbound process of the target container described in the embodiment of FIG. 3. Specifically, the target container is first delivered back to the target rack, and then the target rack is transported back to the warehouse. Details of specific steps are not described again.

In conclusion, after the automated picking task is completed, the target containers are transferred back to the target racks, and the target racks are delivered back to the warehouse. This prevents the target containers from being accumulated on the target conveying belt and affecting subsequent picking operations, and prevents an excessively large quantity of target racks from being located at the target stop point and causing congestion and affecting the picking efficiency.

FIG. 6 is a schematic flowchart of a method for goods sorting according to a sixth embodiment of this application. As shown in FIG. 6, after the generating a sorting instruction according to the source container delivery instruction in S34 in the embodiment of FIG. 3, this embodiment provides an implementation process of verifying a goods sorting result. The process specifically includes the following steps:

Step S61: Determine a verification time node for each source container according to the quantity of sorting operations and the pickup moment of the sorting operation included in the sorting instruction of each source container;

In this embodiment, the sorting instruction sets a picking task of the target items included in the source container. The verification time point is defined as the time point when the picking tasks for the target items in the source container are completed, that is, after the robotic arm is controlled to complete the quantity of sorting operations corresponding to the source container, the step of picking verification is performed.

Step S62: Generate an image acquisition instruction according to the verification time node, and send the image acquisition instruction to an image acquisition apparatus to cause the image acquisition apparatus to capture a to-be-verified image of the target container located in the preset placement location; and

It should be noted that, an image acquisition apparatus, for example, a camera, configured to capture the target container is provided on the picking worktable. In this embodiment, the camera may capture a to-be-verified image in the target container at the preset placement location. Specifically, an image acquisition instruction is generated at the verification time node, and the image acquisition apparatus, that is, the camera, triggers a photographing operation according to the image acquisition instruction to capture a to-be-verified image at the preset placement location.

Step S63: Receive the to-be-verified image sent by the image acquisition apparatus, determine the quantity of to-be-verified items included in the to-be-verified image according to a preset image processing model, and if the quantity of to-be-verified items is not equal to the quantity of sorting operations, generate prompt information and send the prompt information to a management terminal to prompt that goods sorting fails.

It should be noted that, the server stores a preset image processing model for image analysis, to determine the quantity of items included in the to-be-verified image. When the quantity of the to-be-verified items is not equal to the quantity of sorting operations, it indicates that a picking miss or an over-pick occurs. Then, prompt information is generated and sent to the management terminal, to prompt that goods sorting fails and that timely verification needs to be performed on the target items of the target container.

In conclusion, an image acquisition apparatus is added to capture a to-be-verified image in a target container, and the quantity of target items included in the to-be-verified image is determined by using a preset image processing model. In this way, the quantity of target items is verified in a timely manner, thereby improving the accuracy of automated picking.

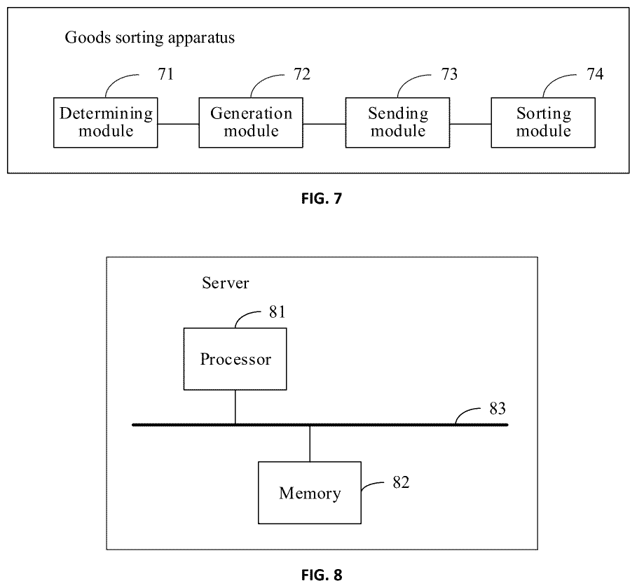

FIG. 7 is a schematic structural diagram of an apparatus for goods sorting according to a seventh embodiment of this application. As shown in FIG. 7, the apparatus for goods sorting provided in this embodiment may include:
a determining module 71, configured to parse received order information to obtain target item information, and determine at least one source container location and a target container location according to the target item information;
a generation module 72, configured to generate a source container delivery instruction according to the at least one source container location, and generate a target container delivery instruction according to the source container delivery instruction and the target container location;
a sending module 73, configured to send the source container delivery instruction of the at least one source container to cause a source delivery assembly to deliver the at least one source container to a preset pickup location, and send the target container delivery instruction to cause a target delivery assembly to deliver a target container to a preset placement location; and
a sorting module 74, configured to generate a sorting instruction corresponding to each source container according to the source container delivery instruction of the at least one source container, and send the sorting instruction to cause a sorting apparatus to pick a target item from the source container located in the preset pickup location and place the target item in the target container located in the preset placement location.

In some possible embodiments, the determining module 71 is specifically configured to:
obtain all target item identifiers included in the target item information;
determine the source container location corresponding to each of the target item identifiers, the source container location including a source rack storage location where the source container is located and a storage location of the source container on a source rack; and
determine the target container location according to a preset distribution rule, the target container location including a target rack storage location where the target container is located and a storage location of the target container on a target rack.

In some possible embodiments, the generation module 72 is specifically configured to:
determine a source rack arrangement order and a source container arrangement order according to the at least one source container location;
determine from the source delivery assembly, a source warehousing robot corresponding to each source rack, and determine a source transfer instruction corresponding to each source rack according to each source rack location and the source rack arrangement order, the source transfer instruction including a source transfer path of the source rack;
determine, from the source delivery assembly, a source handling robot corresponding to each source container, and determine a source handling instruction corresponding to the source container according to the storage location of each source container on the source rack, the source handling instruction including a source handling path of the source container;
generate a source conveying instruction according to the source container arrangement order, the source conveying instruction including conveying times, conveying speeds, and waiting duration of the at least one source container; and
determine the source transfer instruction corresponding to each source rack, the source handling instruction corresponding to each source container, and the source conveying instruction as the source container delivery instruction.

In some possible embodiments, the generation module 72 is specifically configured to:
Determine, from the target delivery assembly, a target warehousing robot corresponding to the source rack, and determine a target transfer instruction according to the target container location, the target transfer instruction including a target transfer path for transferring the target rack;
determine, from the target delivery assembly, a target handling robot corresponding to the source container and determine a target handling instruction according to the storage location of the target container on the target rack, the target handling instruction including a target handling path for handling the target container;
generate a source conveying instruction according to the source container arrangement order, the source conveying instruction including conveying times, conveying speeds, and waiting duration of the at least one source container; and
determine the source transfer instruction corresponding to each source rack, the source handling instruction corresponding to each source container, and the source conveying instruction as the source container delivery instruction.

In some possible embodiments, the sending module 73 is specifically configured to:
send the source transfer instruction corresponding to each source rack to the source warehousing robot corresponding to each source rack to cause the source warehousing robot to transfer the source rack to a preset placement stop point according to the source transfer path included in the source transfer instruction;
separately send the source handling instruction corresponding to each source container to the source handling robot corresponding to each source container to cause each source handling robot to handle the corresponding source container to a placement entrance location of the source conveying apparatus according to the source handling path included in the received source handling instruction; and
send the source conveying instruction corresponding to the at least one source container to the source conveying apparatus to cause the source conveying apparatus to sequentially convey each source container to the preset pickup location according to the conveying times, the conveying speeds, and the waiting duration included in the source conveying instruction corresponding to the at least one source container.

In some possible embodiments, the sending module 73 is specifically configured to:
send the target transfer instruction corresponding to the target rack to the target warehousing robot to cause the target warehousing robot to transfer the target rack to a preset pickup stop point according to the target transfer path included in the target transfer instruction;
send the target handling instruction to the target handling robot to cause the target handling robot to handle the target container to a placement entrance location of the target conveying apparatus according to the target handling path included in the target handling instruction; and
send the target conveying instruction to the target conveying apparatus to cause the target conveying apparatus to convey the target container to the preset placement location according to the conveying time, the conveying speed, and the waiting duration for the target container included in the target conveying instruction.

In some possible embodiments, the sorting module 74 is specifically configured to:
determine a pickup moment of a sorting operation corresponding to the at least one source container according to the conveying times, the conveying speeds, and the waiting duration of the at least one source container included in the source container delivery instruction; and
generate the sorting instruction for each source container according to the quantity of sorting operations and the pickup moment of the sorting operation corresponding to each source container.

In some possible embodiments, the sorting module 74 is specifically configured to:
send the sorting instruction to the sorting robot to cause the sorting robot to pick the target item from the source container located in the preset pickup location according to the pickup moment of the sorting operation included in each sorting instruction and a pickup operation program, place the target item in the target container located in the preset placement location according to a placement operation program, and repeatedly perform pickup operations and placement operations according to the quantity of operations included in the sorting instruction.

In some possible embodiments, the apparatus for goods sorting further includes a parameter setting module, specifically configured to:
determine a pickup operation parameter according to the preset pickup location, and determine a placement operation parameter according to the preset placement location; and
send the pickup operation parameter and the placement operation parameter to the sorting robot to cause the sorting robot to set a pickup operation program according to the pickup operation parameter and set a placement operation program according to the placement operation parameter.

In some possible embodiments, the apparatus for goods sorting further includes a first handling-back module, specifically configured to:
determine a source transfer-back instruction corresponding to each source rack and a source handling-back instruction corresponding to each source container according to the source transfer instructions and the source handling instructions that are included in the source container delivery instruction of the at least one source container;
separately send each source handling-back instruction to the source handling robot corresponding to each source container to cause each source handling robot to handle the corresponding source container back to the corresponding source rack according to the received source handling-back instruction; and
separately send each source transfer-back instruction to the source warehousing robot corresponding to each source rack to cause each source warehousing robot to transfer the corresponding source rack back to the storage location of the corresponding source rack according to the received source transfer-back instruction.

In some possible embodiments, the apparatus for goods sorting further includes a second handling-back module, specifically configured to:
determine a target transfer-back instruction corresponding to the target rack and a target handling-back instruction corresponding to the target container according to a target transfer instruction and a target handling instruction corresponding to the target container that are included in the target container delivery instruction;
send the target handling-back instruction to the target handling robot corresponding to the target container to cause the target handling robot to handle the target container back to the target rack according to the received target handling-back instruction; and
send the target transfer-back instruction to the target warehousing robot to cause the target warehousing robot to transfer the target rack back to a storage location of the target rack according to the received target transfer-back instruction.

In some possible embodiments, the apparatus for goods sorting further includes a verification module, specifically configured to:
determine a verification time node for each source container according to the quantity of sorting operations and the pickup moment of the sorting operation included in the sorting instruction of each source container;
generate an image acquisition instruction according to the verification time node, and send the image acquisition instruction to an image acquisition apparatus to cause the image acquisition apparatus to capture a to-be-verified image of the target container located in the preset placement location; and
receive the to-be-verified image sent by the image acquisition apparatus, determine the quantity of to-be-verified items included in the to-be-verified image according to a preset image processing model, and if the quantity of to-be-verified items is not equal to the quantity of sorting operations, generate prompt information and send the prompt information to a management terminal to prompt that goods sorting fails.

The apparatus for goods sorting provided in this embodiment may be configured to execute the technical solutions of the method embodiments shown in FIG. 3 to FIG. 6. The implementation principles and technical effects thereof are similar. Details are not described herein again.

FIG. 8 is a schematic structural diagram of a server according to an eighth embodiment of this application. As shown in FIG. 8, a server 80 provided in this embodiment includes:
a processor 81; and
a memory 82, configured to store executable instructions of the processor, where the memory may further be a flash memory.

The processor 81 is configured to perform the steps in the foregoing method by executing the executable instructions. For details, refer to the related descriptions in the foregoing method embodiments.

Optionally, the memory 82 may be independent or may be integrated with the processor 81.

When the memory 82 is a device independent of the processor 81, the server 80 may further include:
a system bus 83, configured to connect the processor 81 and the memory 82.

The server provided in this embodiment may be configured to execute the technical solutions of the method embodiments shown in FIG. 3 to FIG. 6. The implementation principles and technical effects thereof are similar. Details are not described herein again.

This embodiment further provides a readable storage medium, and the readable storage medium stores a computer program, where when at least one processor of the server executes the computer program, the server performs the methods provided in the foregoing implementations.

This embodiment further provides a program product, the program product includes a computer program, where the computer program is stored in a readable storage medium. At least one processor of the server may read the computer program from the readable storage medium, and the at least one processor executes the computer program, to cause the server to implement the methods provided in the foregoing implementations.

Finally, it should be noted that: the foregoing embodiments are merely used for describing the technical solutions of this application, but are not intended to limit this application. Although this application is described in detail with reference to the foregoing embodiments, a person of ordinary skill in the art should understand that modifications may still be made to the technical solutions described in the foregoing embodiments, or equivalent replacements may be made to some or all of the technical features; and these modifications or replacements do not cause the essence of corresponding technical solutions to depart from the scope of the technical solutions of the embodiments of this application.

1. A method for goods sorting, wherein the method comprises:
parsing received order information to obtain target item information, and determining at least one source container location and a target container location according to the target item information;
generating a source container delivery instruction according to the at least one source container location, and generating a target container delivery instruction according to the source container delivery instruction and the target container location;
sending the source container delivery instruction of the at least one source container to cause a source delivery assembly to deliver the at least one source container to a preset pickup location, and sending the target container delivery instruction to cause a target delivery assembly to deliver a target container to a preset placement location; and
generating a sorting instruction corresponding to each source container according to the source container delivery instruction of the at least one source container, and sending the sorting instruction to cause a sorting apparatus to pick a target item from the source container located in the preset pickup location and place the target item in the target container located in the preset placement location.

2. The method according to claim 1, wherein the determining at least one source container location and a target container location according to the target item information comprises:
obtaining all target item identifiers comprised in the target item information;
determining the source container location corresponding to each of the target item identifiers, the source container location comprising a source rack storage location wherein the source container is located and a storage location of the source container on a source rack; and
determining the target container location according to a preset distribution rule, the target container location comprising a target rack storage location wherein the target container is located and a storage location of the target container on a target rack.

3. The method according to claim 2, wherein the generating a source container delivery instruction according to the at least one source container location comprises:
determining a source rack arrangement order and a source container arrangement order according to the at least one source container location;
determining, from the source delivery assembly, a source warehousing robot corresponding to each source rack, and determining a source transfer instruction corresponding to each source rack according to each source rack location and the source rack arrangement order, the source transfer instruction comprising a source transfer path of the source rack;
determining, from the source delivery assembly, a source handling robot corresponding to each source container, and determining a source handling instruction corresponding to the source container according to the storage location of each source container on the source rack, the source handling instruction comprising a source handling path of the source container;
generating a source conveying instruction according to the source container arrangement order, the source conveying instruction comprising conveying times, conveying speeds, and waiting duration of the at least one source container; and
determining the source transfer instruction corresponding to each source rack, the source handling instruction corresponding to each source container, and the source conveying instruction as the source container delivery instruction.

4. The method according to claim 2, wherein the generating a target container delivery instruction according to the source container delivery instruction and the target container location comprises:
determining, from the target delivery assembly, a target warehousing robot corresponding to the source rack, and determining a target transfer instruction according to the target container location, the target transfer instruction comprising a target transfer path for transferring the target rack;
determining, from the target delivery assembly, a target handling robot corresponding to the source container and determining a target handling instruction according to the storage location of the target container on the target rack, the target handling instruction comprising a target handling path for handling the target container;
generating a target conveying instruction according to a source conveying instruction comprised in the source container delivery instruction, the target conveying instruction comprising a conveying time, a conveying speed, and a waiting duration for conveying the target container; and
determining the target transfer instruction, the target handling instruction, and the target conveying instruction as the target container delivery instruction.

5. The method according to claim 3, wherein the source delivery assembly comprises a source conveying apparatus, and the sending the source container delivery instruction of the at least one source container to cause a source delivery assembly to deliver the at least one source container to a preset pickup location comprises:
sending the source transfer instruction corresponding to each source rack to the source warehousing robot corresponding to each source rack to cause the source warehousing robot to transfer the source rack to a preset placement stop point according to the source transfer path comprised in the source transfer instruction;
separately sending the source handling instruction corresponding to each source container to the source handling robot corresponding to each source container to cause each source handling robot to handle the corresponding source container to a placement entrance location of the source conveying apparatus according to the source handling path comprised in the received source handling instruction; and
sending the source conveying instruction corresponding to the at least one source container to the source conveying apparatus to cause the source conveying apparatus to sequentially convey each source container to the preset pickup location according to the conveying times, the conveying speeds, and the waiting duration comprised in the source conveying instruction corresponding to the at least one source container.

6. The method according to claim 4, wherein the target delivery assembly comprises a target conveying apparatus, and the sending the target container delivery instruction to cause a target delivery assembly to deliver a target container to a preset placement location comprises:
sending the target transfer instruction corresponding to the target rack to the target warehousing robot to cause the target warehousing robot to transfer the target rack to a preset pickup stop point according to the target transfer path comprised in the target transfer instruction;
sending the target handling instruction to the target handling robot to cause the target handling robot to handle the target container to a placement entrance location of the target conveying apparatus according to the target handling path comprised in the target handling instruction; and
sending the target conveying instruction to the target conveying apparatus to cause the target conveying apparatus to convey the target container to the preset placement location according to the conveying time, the conveying speed, and the waiting duration for the target container comprised in the target conveying instruction.

7. The method according to claim 3, wherein the generating a sorting instruction corresponding to each source container according to the source container delivery instruction of the at least one source container comprises:
determining a pickup moment of a sorting operation corresponding to the at least one source container according to the conveying times, the conveying speeds, and the waiting duration of the at least one source container comprised in the source container delivery instruction; and
generating the sorting instruction for each source container according to the quantity of sorting operations and the pickup moment of the sorting operation corresponding to each source container.

8. The method according to claim 7, wherein the sending the sorting instruction to cause a sorting apparatus to pick a target item from the source container located in the preset pickup location and place the target item in the target container located in the preset placement location comprises:
sending the sorting instruction to the sorting robot to cause the sorting robot to pick the target item from the source container located in the preset pickup location according to the pickup moment of the sorting operation comprised in each sorting instruction and a pickup operation program, place the target item in the target container located in the preset placement location according to a placement operation program, and repeatedly perform pickup operations and placement operations according to the quantity of operations comprised in the sorting instruction.

9. The method according to claim 1, wherein the sorting apparatus is a sorting robot, and before the sending the sorting instruction, the method further comprises:
determining a pickup operation parameter according to the preset pickup location, and determining a placement operation parameter according to the preset placement location; and
sending the pickup operation parameter and the placement operation parameter to the sorting robot to cause the sorting robot to set a pickup operation program according to the pickup operation parameter and set a placement operation program according to the placement operation parameter.

10. The method according to claim 3, wherein after the sending the sorting instruction, the method further comprises:
determining a source transfer-back instruction corresponding to each source rack and a source handling-back instruction corresponding to each source container according to the source transfer instructions and the source handling instructions that are comprised in the source container delivery instruction of the at least one source container;
separately sending each source handling-back instruction to the source handling robot corresponding to each source container to cause each source handling robot to handle the corresponding source container back to the corresponding source rack according to the received source handling-back instruction; and
separately sending each source transfer-back instruction to the source warehousing robot corresponding to each source rack to cause each source warehousing robot to transfer the corresponding source rack back to the storage location of the corresponding source rack according to the received source transfer-back instruction.

11. The method according to claim 4, wherein after the sending the sorting instruction, the method further comprises:
determining a target transfer-back instruction corresponding to the target rack and a target handling-back instruction corresponding to the target container according to a target transfer instruction and a target handling instruction corresponding to the target container that are comprised in the target container delivery instruction;
sending the target handling-back instruction to the target handling robot corresponding to the target container to cause the target handling robot to handle the target container back to the target rack according to the received target handling-back instruction; and
sending the target transfer-back instruction to the target warehousing robot to cause the target warehousing robot to transfer the target rack back to a storage location of the target rack according to the received target transfer-back instruction.

12. The method according to claim 1, wherein after the generating a sorting instruction corresponding to each source container according to the source container delivery instruction of the at least one source container, the method further comprises:
determining a verification time node for each source container according to the quantity of sorting operations and the pickup moment of the sorting operation comprised in the sorting instruction of each source container;
generating an image acquisition instruction according to the verification time node, and sending the image acquisition instruction to an image acquisition apparatus to cause the image acquisition apparatus to capture a to-be-verified image of the target container located in the preset placement location; and
receiving the to-be-verified image sent by the image acquisition apparatus, determining the quantity of to-be-verified items comprised in the to-be-verified image according to a preset image processing model, and if the quantity of to-be-verified items is not equal to the quantity of sorting operations, generating prompt information and sending the prompt information to a management terminal to prompt that goods sorting fails.

13. A server, comprising a memory and at least one processor, wherein
the memory is configured to store computer-executable instructions; and
the at least one processor is configured to execute the computer-executable instructions stored in the memory, to cause the at least one processor to:
parse received order information to obtain target item information, and determine at least one source container location and a target container location according to the target item information;
generate a source container delivery instruction according to the at least one source container location, and generate a target container delivery instruction according to the source container delivery instruction and the target container location;
send the source container delivery instruction of the at least one source container to cause a source delivery assembly to deliver the at least one source container to a preset pickup location, and send the target container delivery instruction to cause a target delivery assembly to deliver a target container to a preset placement location; and
generate a sorting instruction corresponding to each source container according to the source container delivery instruction of the at least one source container, and send the sorting instruction to cause a sorting apparatus to pick a target item from the source container located in the preset pickup location and place the target item in the target container located in the preset placement location.

14. A system for goods sorting, comprising: a server, a source delivery assembly, a target delivery assembly, a sorting apparatus, a rack, and a picking workstation, wherein
the rack comprises a source rack and a target rack, wherein the source rack is configured to store a source container, and the target rack is configured to store a target container;
the source delivery assembly is configured to deliver the at least one source container to a preset pickup location of the picking workstation in response to a source container delivery instruction;
the target delivery assembly is configured to deliver the target container to a preset placement location of the picking workstation in response to a target container delivery instruction;
the sorting apparatus is configured to pick a target item from the source container located in the preset pickup location and place the target item in the target container located in the preset placement location in response to a sorting instruction; and
the server comprising a memory and at least one processor, wherein the memory is configured to store computer-executable instructions; and
the at least one processor is configured to execute the computer-executable instructions stored in the memory, to cause the at least one processor to:
parse received order information to obtain target item information, and determine at least one source container location and a target container location according to the target item information;
generate a source container delivery instruction according to the at least one source container location, and generate a target container delivery instruction according to the source container delivery instruction and the target container location;
send the source container delivery instruction of the at least one source container to cause a source delivery assembly to deliver the at least one source container to a preset pickup location, and send the target container delivery instruction to cause a target delivery assembly to deliver a target container to a preset placement location; and
generate a sorting instruction corresponding to each source container according to the source container delivery instruction of the at least one source container, and send the sorting instruction to cause a sorting apparatus to pick a target item from the source container located in the preset pickup location and place the target item in the target container located in the preset placement location.

15. A non-transitory computer-readable storage medium, wherein the computer-readable storage medium is configured to store computer-executable instruction, and a processor, when executing the computer-executable instructions, is configured to:
parse received order information to obtain target item information, and determine at least one source container location and a target container location according to the target item information;
generate a source container delivery instruction according to the at least one source container location, and generate a target container delivery instruction according to the source container delivery instruction and the target container location;
send the source container delivery instruction of the at least one source container to cause a source delivery assembly to deliver the at least one source container to a preset pickup location, and send the target container delivery instruction to cause a target delivery assembly to deliver a target container to a preset placement location; and
generate a sorting instruction corresponding to each source container according to the source container delivery instruction of the at least one source container, and send the sorting instruction to cause a sorting apparatus to pick a target item from the source container located in the preset pickup location and place the target item in the target container located in the preset placement location.
